(19) United States
(12) Patent Application Publication
(10) Pub. No.: US 2012/0052385 A1
(43) Pub. Date: Mar. 1, 2012

(54) NONAQUEOUS ELECTROLYTE SECONDARY BATTERY AND METHOD FOR MANUFACTURING THE SAME

(75) Inventors: Hiroshi Minami, Kobe-shi (JP); Naoki Imachi, Kobe-shi (JP)

(73) Assignee: SANYO ELECTRIC CO., LTD., Osaka (JP)

(21) Appl. No.: 13/215,609

(22) Filed: Aug. 23, 2011

(30) Foreign Application Priority Data
Aug. 30, 2010 (JP) 2010-191816

(51) Int. Cl. H01M 4/62; H01M 10/04; H01M 4/139

(52) U.S. Cl. 429/215; 29/623.2; 29/623.5

(57) ABSTRACT

A nonaqueous electrolyte secondary battery including a negative electrode having a negative electrode mixture layer on at least one surface of a negative collector; a positive electrode; a separator disposed between the positive electrode and the negative electrode; and a nonaqueous electrolyte, wherein the negative electrode mixture layer contains a negative electrode active material, poly(ethylene oxide), carboxymethylcellulose, and styrene-butadiene rubber, the mass of the carboxymethylcellulose is greater than the mass of the poly(ethylene oxide), and the percentage of the total amount of the carboxymethylcellulose and the lithium ion conducting polymer with respect to the total amount of the negative electrode mixture layer is 0.2% by mass or more and 2.2% by mass or less.

### CROSS REFERENCE TO RELATED APPLICATIONS

The present invention claims priority to Japanese Patent Application No. 2010-191816 filed in the Japan Patent Office on Aug. 30, 2010, the entire contents of which are incorporated herein by reference.

### BACKGROUND OF THE INVENTION

1. Field of the Invention

The present invention relates to a nonaqueous electrolyte secondary battery and a method for manufacturing the nonaqueous electrolyte secondary battery.

2. Description of Related Art

With recent rapid advances in small lightweight mobile information terminals, such as mobile phones, notebook computers, and personal data assistants (PDAs), there is a growing demand for high-capacity batteries serving as driving sources therefor. Furthermore, nonaqueous electrolyte secondary batteries are increasingly used in applications requiring high output power, such as hybrid electric vehicles (HEVs) and electric power tools. Thus, there are two directions for the future development of nonaqueous electrolyte secondary batteries: higher capacity and higher power.

In order to increase the capacity of batteries, high-capacity positive electrode materials substituting for lithium cobalt oxide and high-capacity negative electrode materials substituting for graphite are being developed. Existing nonaqueous electrolyte secondary batteries utilizing the mainstream materials, lithium cobalt oxide and graphite, have excellent performance balance. In addition, various mobile devices have been designed to conform to the characteristics of these secondary batteries. Thus, a little progress has been made toward developing high-capacity electrode materials substituting for lithium cobalt oxide and graphite. In particular, a change of the negative electrode material greatly alters the charge and discharge curve and the operating voltage of the battery. It is therefore particularly difficult to develop high-capacity negative electrode materials substituting for graphite.

Nevertheless, with increasing power consumption of mobile devices, a further increase in battery capacity is strongly demanded. Such a demand for high capacity must presently be satisfied by an increase in the charging density of the graphite negative electrode or an increase in the thickness of the negative electrode mixture layer.

In order to improve the storage characteristics of a graphite negative electrode, carbon particles can be coated with poly(ethylene oxide) (PEO) (see Japanese Published Unexamined Patent Application No. 9-45328 (Patent Document 1)).

However, this method requires the use of an organic solvent (solvent slurry) in the manufacture of the negative electrode and consequently increases environmental load in the manufacture of the battery. Reduction in environmental load requires high-performance (and large-size) apparatuses for manufacturing batteries, which increase the manufacturing costs of the batteries.

Accordingly, in order to reduce an increase in the manufacturing costs and reduce the environmental load in the manufacture of batteries, use of an aqueous slurry in the manufacture of negative electrodes has been proposed. One known aqueous slurry contains a negative electrode active material, such as graphite, a thickener carboxymethylcellulose (CMC), and a latex binder, such as styrene-butadiene rubber (SBR) (see Japanese Published Unexamined Patent Application No. 2002-175807 (Patent Document 2)). The negative electrode active material is covered with CMC and is prevented from being aggregated with SBR, providing slurry suitable for coating.

However, since CMC covering the negative electrode active material has no lithium ion conductivity, CMC reduces the diffusion velocity of lithium during charge and discharge. This makes it difficult for lithium ions to enter the negative electrode active material, possibly causing the deposition of lithium on the surface of the negative electrode active material. The deposited lithium may cause a short circuit in the battery, lowering the reliability of the battery.

Although not intending to reduce the deposition of lithium, it is proposed that in a battery manufactured using an aqueous slurry, a lithium ion conducting polymer, such as PEO, is introduced into a negative electrode, and the amount of PEO is defined by the amount of electrolyte (see Japanese Published Unexamined Patent Application No. 2005-32549 (Patent Document 3)). Patent Document 3 discloses that this allows the swelling of PEO to be controlled, thereby improving cycling characteristics. However, correlating the amount of PEO only with the amount of electrolyte may result in the deposition of lithium on the surface of the negative electrode active material, lowering the reliability of the battery or lowering dispersibility of the negative electrode active material in the slurry.

### BRIEF SUMMARY OF THE INVENTION

To solve the problems described above, it is an object of the present invention to reduce the deposition of lithium on the surface of a negative electrode active material, improving the reliability of the battery, and improve the dispersion of the negative electrode active material in slurry, maintaining high dispersion stability in a negative electrode mixture layer.

An embodiment of the present invention is a nonaqueous electrolyte secondary battery including a negative electrode having a negative electrode mixture layer on at least one surface of a negative collector; a positive electrode; a separator disposed between these positive and negative electrodes; and a nonaqueous electrolyte, wherein the negative electrode mixture layer contains a negative electrode active material, a lithium ion conducting polymer, carboxymethylcellulose (hereinafter also referred to as CMC), and a latex binder, the mass of the CMC is equal to or greater than the mass of the lithium ion conducting polymer, and the percentage of the total amount of the CMC and the lithium ion conducting polymer with respect to the total amount of the negative electrode mixture layer is 0.2% by mass or more and 2.2% by mass or less.

The addition of the lithium ion conducting polymer to the negative electrode mixture layer results in the formation of a composite film containing the lithium ion conducting polymer in CMC. The composite film covers the negative electrode active material. As compared with a conventional negative electrode in which a negative electrode active material is covered with a CMC film alone, the addition of the lithium ion conducting polymer can reduce the diffusion resistance of lithium, thereby preventing lithium from being deposited on the surface of the negative electrode active material. Furthermore, the mass of CMC, which has a higher dispersant function than the lithium ion conducting polymer, equal to or greater than the mass of the lithium ion conducting polymer results in improvement in the dispersibility of the negative electrode mixture slurry in the manufacture of the negative electrode. Thus, in the negative electrode made from the negative electrode mixture slurry, the negative electrode active material has improved dispersion stability in the negative electrode mixture layer.

The percentage of the total amount of the CMC and the lithium ion conducting polymer with respect to the total amount of the negative electrode mixture layer is 0.2% by mass or more and 2.2% by mass or less. The reason for this is as follows: A higher percentage of the total amount of the CMC and the lithium conducting polymer with respect to the total amount of the negative electrode mixture layer tends to result in higher dispersion stability of the negative electrode active material in the negative electrode mixture layer. However, a percentage of more than 2.2% by mass results in a low deintercalation efficiency of lithium ions in the negative electrode active material, increasing the deposition of lithium on the surface of the negative electrode active material. On the other hand, when the percentage of the total amount of the CMC and the lithium ion conducting polymer with respect to the total amount of the negative electrode mixture layer is less than 0.2% by mass, the negative electrode active material may have insufficient dispersion stability in the negative electrode mixture layer.

Considering these, the percentage of the total amount of the CMC and the lithium ion conducting polymer with respect to the total amount of the negative electrode mixture layer is preferably 0.5% by mass or more and 1.5% by mass or less.

It is desirable that the mass ratio of the lithium ion conducting polymer to the CMC is 0/10 or more and 4/6 or less.

A mass ratio of the lithium ion conducting polymer to the CMC of 4/6 or less results in further improved dispersibility of the negative electrode mixture slurry, further improving the dispersion stability of the negative electrode active material in the negative electrode mixture layer. On the other hand, since even a small amount of lithium ion conducting polymer can reduce the diffusion resistance of lithium, the mass ratio of the lithium ion conducting polymer to the CMC is 0/10 or more.

Preferred lithium ion conducting polymers are poly(ethylene oxide) (hereinafter also referred to as PEO) and/or a poly(ethylene oxide) derivative (hereinafter also referred to as a PEO derivative).

PEO or a PEO derivative has high lithium ion conductivity and can facilitate lithium intercalation in the negative electrode, thereby reducing the deposition of lithium. Furthermore, PEO or a PEO derivative can dissolve in water and increase viscosity. Thus, PEO or a PEO derivative can reduce the amount of CMC, which also functions as a thickener. This can reduce the total amount of CMC and PEO or PEO derivative and accordingly increase the percentage of the negative electrode active material, resulting in an increase in the capacity of the negative electrode. Furthermore, PEO or a PEO derivative has a high resistance to reduction and is negligibly reduced in the negative electrode. Thus, the addition of PEO or a PEO derivative does not significantly affect the battery characteristics.

Non-limiting examples of the PEO derivative include PEO having a sulfo group, a carboxy group, and/or an amine group. Non-limiting examples of the lithium ion conducting polymer include PEO, PEO derivatives, poly(methyl methacrylate) (PMMA), and polyacrylonitrile (PAN).

PEO and a PEO derivative preferably have a molecular weight in the range of 50,000 to 1,000,000, particularly preferably 100,000 to 600,000. PEOs having a molecular weight of 50,000 or less include poly(ethylene glycol) (hereinafter also referred to as PEG). PEOs having a molecular weight of 50,000 or less have a low resistance to reduction and may affect the battery characteristics and have a small thickening effect, resulting in poor applicability of the negative electrode mixture slurry. On the other hand, with PEOs having a molecular weight of 1,000,000 or more, the negative electrode active material is covered with a thick polymer film, resulting in low lithium ion conductivity. This induces the deposition of lithium or the aggregation of the negative electrode active material, resulting in low dispersibility in the negative electrode mixture layer.

A method for manufacturing a nonaqueous electrolyte secondary battery includes mixing a negative electrode active material with an aqueous solution containing CMC to form a mixture and adding a lithium ion conducting polymer and a latex binder to the mixture to form a negative electrode mixture slurry; applying the negative electrode mixture slurry to at least one surface of a negative collector to form a negative electrode; and placing a separator between the negative electrode and a positive electrode to form an electric-power generating element and impregnating the electric-power generating element with a nonaqueous electrolyte.

CMC functions as a dispersant in the negative electrode mixture slurry and is adsorbed on the negative electrode active material to effectively maintain the dispersion stability of the negative electrode mixture slurry. A lithium ion conducting polymer generally has a smaller effect as a dispersant than CMC and a smaller effect of improving the dispersion stability of the negative electrode mixture slurry than CMC. Thus, as in the manufacturing method described above, mixing a negative electrode active material with an aqueous solution containing CMC before the addition of a lithium ion conducting polymer allows CMC to be adsorbed on the surface of the negative electrode active material. This can improve the dispersion stability of the negative electrode mixture slurry.

### Other Items

(1) Non-limiting examples of the latex binder include, but are not limited to, styrene-butadiene rubber (SBR), acrylonitrile-butadiene rubber, acrylate latex, vinyl acetate latex, methyl methacrylate-butadiene latex, and carboxy-modified products thereof. Among these, SBR having a high lithium ion conductivity is preferably used as the latex binder.

The percentage of the latex binder with respect to the total amount of the negative electrode mixture layer is preferably 0.5% by mass or more and 2.0% by mass or less, particularly preferably 0.5% by mass or more and 1.5% by mass or less. A percentage of the latex binder of more than 2.0% by mass tends to result in low deintercalation efficiency of lithium ions in the negative electrode active material. A percentage of the latex binder of less than 0.5% by mass tends to result in insufficient binding power.

(2) The negative electrode active material may be any material that allows reversible intercalation and deintercalation of lithium. Non-limiting examples of the negative electrode active material include carbon materials, tin oxide, metallic lithium, silicon, and mixtures thereof. Among them, carbon materials are preferably used as the negative electrode active material in terms of electrode characteristics and cost.

Non-limiting examples of the carbon materials include natural graphite, artificial graphite, mesophase pitch carbon fiber (MCF), mesocarbon microbeads (MCMB), coke, hard carbon, fullerene, and carbon nanotubes. Among these, graphite, such as natural graphite or artificial graphite, is particularly preferred because of small variations in electric potential associated with the intercalation and deintercalation of lithium.

(3) The positive electrode may be any electrode that can generally be used in nonaqueous electrolyte secondary batteries. In general, the positive electrode contains a positive collector and a positive electrode mixture layer containing a positive electrode active material disposed on the positive collector. The positive collector may be, but not limited to, aluminum foil.

Non-limiting examples of the positive electrode active material include, but are not limited to, lithium cobalt oxide, nickel-containing lithium composite oxide, spinel lithium manganate, and olivine lithium iron phosphate. Non-limiting examples of the nickel-containing lithium composite oxide include lithium composite oxide of Ni—Co—Mn, lithium composite oxide of Ni—Mn—Al, and lithium composite oxide of Ni—Co—Al. These positive electrode active materials may be used alone or in combination.

(4) The nonaqueous electrolyte generally contains a supporting electrolyte and a solvent. The supporting electrolyte may contain lithium or not. Non-limiting examples of the supporting electrolyte containing lithium include LiPF₆, LiBF₄, LiN(SO₂CF₃)₂, LiN(SO₂C₂F₅)₂, and LiPF₍₅₋ₓ₎(CₙF₍₂ₙ₊₁₎)ₓ (wherein 1<x<6, n=1 or 2). These supporting electrolytes may be used alone or in combination. The concentration of the supporting electrolyte in the nonaqueous electrolyte is probably, but not limited to, in the range of 1.0 to 1.8 mol/l.

Non-limiting examples of the solvent include carbonate solvents, such as ethylene carbonate (EC), diethylene carbonate (DEC), propylene carbonate (PC), γ-butyrolactone (GBL), ethylmethyl carbonate (EMC), and dimethyl carbonate (DMC). These carbonate solvents may be used alone or in combination. If used in combination, a mixed solvent of a cyclic carbonate solvent and a chain carbonate solvent is preferred.

(5) The final charging voltage of a battery according to the present invention is, but not limited to, approximately 4.2 V or more.

In accordance with the present invention, the deposition of lithium on the surface of a negative electrode active material can be reduced. This can improve the reliability of the battery. Furthermore, the dispersion of the negative electrode active material in slurry is improved. This is effective in maintaining high dispersion stability in the negative electrode mixture layer.

### DETAILED DESCRIPTION OF THE INVENTION

The present invention is not limited to the following examples, and various modifications may be made in it without departing from the gist of the present invention.

### Preparation of Negative Electrode

CMC [manufactured by Daicel Chemical Industries, Ltd., product number 1380 (the degree of etherification: 1.0 to 1.5)] was dissolved in deionized water to prepare an aqueous 1.0% by mass CMC solution. A lithium ion conducting polymer PEO (poly(ethylene oxide) manufactured by Sigma-Aldrich Co., molecular weight: 300,000) was dissolved in deionized water to prepare an aqueous 5.0% by mass PEO solution.

Next, 320 g of the aqueous 1.0% by mass CMC solution was mixed with 392 g of artificial graphite (average particle size: 21 μm, surface area: 4.0 m2/g), which is a negative electrode active material. The mixture was then mixed with 16 g of the aqueous 5.0% by mass PEO solution. The mixture was then mixed with 8.2 g of SBR and deionized water serving as a viscosity modifier to prepare a negative electrode mixture slurry. The solid content of SBR was 48.8%.

This negative electrode mixture slurry was then applied to both faces of a negative collector made of copper foil, was dried, and was rolled to prepare a negative electrode such that the density of the negative electrode mixture layer was 1.60 g/cc.

The mass ratio of artificial graphite:CMC:PEO:SBR in the negative electrode mixture layer was 98:0.8:0.2:1. The percentage of the total amount of CMC and PEO with respect to the total amount of solids in the negative electrode mixture slurry was 1.0% by mass (in other words, after the preparation of the negative electrode, the percentage of the total amount of CMC and PEO with respect to the total amount of negative electrode mixture layer was 1.0% by mass).

### Preparation of Positive Electrode

A diluent solvent N-methyl-2-pyrrolidone (NMP), a lithium cobalt oxide positive electrode active material, an acetylene black carbon conductive agent, and a PVDF binder were mixed at a mass ratio of lithium cobalt oxide:acetylene black:PVDF=95:2.5:2.5 to prepare a positive electrode mixture slurry. This positive electrode mixture slurry was then applied to both faces of a positive collector made of aluminum foil, was dried, and was rolled to prepare a positive electrode such that the density of the positive electrode mixture layer was 3.60 g/cc.

### Preparation of Nonaqueous Electrolyte

Lithium hexafluorophosphate (LiPF₆) was dissolved at 1.0 mol/l in a mixed solvent of EC and DEC at a volume ratio of EC:DEC=3:7 to prepare a nonaqueous electrolyte.

### Fabrication of Battery

A lead terminal was attached to each of the positive electrode and the negative electrode. The polyethylene positive and negative electrodes were wound up into a roll with a separator interposed therebetween and were pressed to form a flat electrode set. The electrode set was placed in an aluminum laminate battery case. The nonaqueous electrolyte was injected into the battery case, which was then sealed to fabricate a battery. The capacity ratio of the unit area of the negative electrode to the unit area of the positive electrode in the battery was 1.10. The capacity per unit area is greater in the negative electrode than in the positive electrode. In the fabrication of the battery, the capacity of the battery was set at 800 mAh based on a final charging voltage of 4.2 V.

### EXAMPLES

### First Example

### Example 1

A negative electrode and a battery were fabricated in the same manner as in the method described in the detailed description of the invention.

The negative electrode and the battery thus fabricated are hereinafter referred to as a negative electrode a1 and a battery A1.

### Example 2

A negative electrode and a battery were fabricated in the same manner as in the example 1 except that the mass ratio (PEO/CMC) of PEO to CMC in the preparation of the negative electrode mixture slurry was 0.5/9.5. The percentage of the total amount of CMC and PEO with respect to the total amount of the solid content of the negative electrode mixture slurry was 1.0% by mass, which was the same as in the example 1. This applies to the examples 3 and 4.

The negative electrode and the battery thus fabricated are hereinafter referred to as a negative electrode a2 and a battery A2.

### Example 3

A negative electrode and a battery were fabricated in the same manner as in the example 1 except that the mass ratio (PEO/CMC) of PEO to CMC in the preparation of the negative electrode mixture slurry was 4/6.

The negative electrode and the battery thus fabricated are hereinafter referred to as a negative electrode a3 and a battery A3.

### Example 4

A negative electrode and a battery were fabricated in the same manner as in the example 1 except that the mass ratio (PEO/CMC) of PEO to CMC in the preparation of the negative electrode mixture slurry was 5/5.

The negative electrode and the battery thus fabricated are hereinafter referred to as a negative electrode a4 and a battery A4.

### Comparative Example 1

A negative electrode and a battery were fabricated in the same manner as in the example 1 except that a negative electrode mixture slurry was prepared without the addition of PEO such that the mass ratio of artificial graphite, CMC, and SBR was artificial graphite:CMC:SBR=98:1:1.

The negative electrode and the battery thus fabricated are hereinafter referred to as a negative electrode z1 and a battery Z1.

### Comparative Example 2

A negative electrode was prepared in the same manner as in the example 1 except that a negative electrode mixture slurry was prepared without the addition of CMC such that the mass ratio of artificial graphite, PEO, and SBR satisfied artificial graphite:PEO:SBR=98:1:1. The negative electrode mixture slurry according to the comparative example 2 produced a large amount of precipitation and had markedly deteriorated applicability. Thus, a battery was not fabricated and was not assessed.

The negative electrode thus prepared is hereinafter referred to as a negative electrode z2.

### Experiment 1

Each of the negative electrode mixture slurries used in the preparation of the negative electrodes a1 to a4, z1, and z2 was weighed into a transparent container. After leaving the mixture slurries to stand for one day, the amount of supernatant was measured to assess precipitation. More specifically, the degree of precipitation was calculated in accordance with the following equation (1) from the level of the mixture slurry before the precipitation test and the level of the supernatant liquid after leaving the mixture slurry to stand for one day. The degree of precipitation was assessed in accordance with the following criteria. Table 1 shows the results.

Degree of precipitation=(the level of the supernatant liquid after leaving the mixture slurry to stand for one day)/(the level of the mixture slurry before the precipitation test) (1)
Good: A degree of precipitation of 0.0 or more and less than 0.3
Fair: A degree of precipitation of 0.3 or more and less than 0.7
Poor: A degree of precipitation of 0.7 or more

### Experiment 2

The batteries A1 to A4 and Z1 were charged and discharged under the following conditions. The low-temperature characteristic value was determined in accordance with the following equation (2) from the charge capacity at −5° C. and the discharge capacity at 25° C. Table 1 shows the results. The amount of lithium deposition was roughly estimated from the low-temperature characteristic value. More specifically, if the low-temperature characteristic value is 94%, the amount of lithium deposition on the negative electrode is estimated to be 6% (100%−94%).

Low-temperature characteristic value [%]=[(discharge capacity at 25° C.)/(charge capacity at −5° C.)]×100 (2)

### Charge and Discharge Conditions

A constant-current charge at an environmental temperature of −5° C. at an electric current of 1.0 It (800 mA) was performed up to a battery voltage of 4.35 V. A charge at a constant voltage of 4.35 V was then performed up to an electric current of It/20 (40 mA). This charge capacity corresponds to a charge capacity at −5° C. At an environmental temperature of 25° C., the battery was held at rest at 25° C. for three hours. A constant-current discharge at an environmental temperature of 25° C. at an electric current of 1.0 It (800 mA) was then performed up to a battery voltage of 2.75 V. The discharge capacity at 25° C. was calculated.

TABLE 1

| | Percentage | | | |
|---|---|---|---|---|
| | of the amount | | | |
| | of PEO and CMC | | | Low-tem- |
| | with respect to | PEO/ | | perature |
| Battery No. | the amount of | CMC | Degree | charac- |
| (Negative | negative electrode | mass | of precip- | teristic |
| electrode No.) | mixture layer | ratio | itation | value |
| Battery A2 | 1.0 mass % | 0.5/9.5 | Good | 94% |
| (Negative | | | | |
| electrode a2) | | | | |
| Battery A1 | | 2/8 | Good | 95% |
| (Negative | | | | |
| electrode a1) | | | | |
| Battery A3 | | 4/6 | Good | 94% |
| (Negative | | | | |
| electrode a3) | | | | |
| Battery A4 | | 5/5 | Fair | 91% |
| (Negative | | | | |
| electrode a4) | | | | |
| Battery Z1 | | 0/10 | Good | 90% |
| (Negative | | | | |
| electrode z1) | | | | |
| — | | 10/0 | Poor | — |
| (Negative | | | | |
| electrode z2) | | | | |

As is clear from Table 1, the negative electrode mixture slurries for the negative electrodes a1 to a4, in which CMC and PEO were added to the slurries and the mass of CMC was equal to or greater than the mass of PEO, produced a reduced amount of precipitation. The batteries A1 to A4, which included these negative electrodes, had improved low-temperature characteristics (the deposition of lithium on the surface of the negative electrode could be controlled).

In contrast, the negative electrode mixture slurry for the negative electrode z2, in which PEO alone (no CMC) was added to the slurry, produced a large amount of precipitation. The negative electrode mixture slurry for the negative electrode z1, in which CMC alone (no PEO) was added to the slurry, produced a reduced amount of precipitation. However, the battery Z1, which included negative electrode z1, had poor low low-temperature characteristics (the deposition of lithium on the surface of the negative electrode increased).

The negative electrode mixture slurry for the negative electrode a4, in which the mass of CMC was equal to the mass of PEO, produced a slightly larger amount of precipitation than the negative electrode mixture slurries for the negative electrodes a1 to a3, in which the mass of CMC was greater than the mass of PEO. The battery A4, which included the negative electrode a4, had a less low-temperature characteristic value than the batteries A1 to A3, which included the negative electrodes a1 to a3 (a smaller effect of reducing the deposition of lithium on the surface of the negative electrode). Thus, the mass of CMC smaller than the mass of PEO results in a large amount of precipitation and poor low low-temperature characteristics. Hence, a desired negative electrode could not be fabricated. In the negative electrode mixture slurries, therefore, the mass of CMC must be equal to or greater than the mass of PEO.

### Second Example

### Example 1

A negative electrode and a battery were fabricated in the same manner as in the example 1 of the first example except that the negative electrode mixture slurry was prepared such that the mass ratio of materials in the negative electrode mixture layer was artificial graphite:CMC:PEO:SBR=98.5:0.4:0.1:1.0. The percentage of the total amount of CMC and PEO with respect to the total amount of the negative electrode mixture layer was 0.5% by mass.

The negative electrode and the battery thus fabricated are hereinafter referred to as a negative electrode b1 and a battery B1.

### Example 2

A negative electrode and a battery were fabricated in the same manner as in the example 1 of the first example except that the negative electrode mixture slurry was prepared such that the mass ratio of materials in the negative electrode mixture layer was artificial graphite:CMC:PEO:SBR=97.0:1.6:0.4:1.0. The percentage of the total amount of CMC and PEO with respect to the total amount of the negative electrode mixture layer was 2.0% by mass.

The negative electrode and the battery thus fabricated are hereinafter referred to as a negative electrode b2 and a battery B2.

### Comparative Example

A negative electrode and a battery were fabricated in the same manner as in the comparative example 1 of the first example except that the negative electrode mixture slurry was prepared such that the mass ratio of materials in the negative electrode mixture layer was artificial graphite:CMC:SBR=97.0:2.0:1.0.

The negative electrode and the battery thus fabricated are hereinafter referred to as a negative electrode y and a battery Y.

### Experiment 1

The precipitation of the negative electrode mixture slurries used in the preparation of the negative electrodes b1, b2, and y was examined in the same manner as in the experiment 1 of the first example. Table 2 shows the results. Table 2 also shows the precipitation of the negative electrode mixture slurry used in the preparation of the negative electrode a1 and the negative electrode mixture slurry used in the preparation of the negative electrode z1.

### Experiment 2

The low-temperature characteristics of the batteries B1, B2, and Y were examined in the same manner as in the experiment 2 of the first example. Table 2 shows the results. Table 2 also shows the low-temperature characteristic values of the battery A1 and the battery Z1.

TABLE 2

| | | Percentage | | |
|---|---|---|---|---|
| | | of the amount | | |
| | | of PEO and CMC | | Low-tem- |
| | PEO/ | with respect to | | perature |
| Battery No. | CMC | the amount of | Degree | charac- |
| (Negative | mass | negative electrode | of precip- | teristic |
| electrode No.) | ratio | mixture layer | itation | value |
| Battery B1 | 2/8 | 0.5 mass % | Fair | 94% |
| (Negative | | | | |
| electrode b1) | | | | |
| Battery A1 | | 1.0 mass % | Good | 95% |
| (Negative | | | | |
| electrode a1) | | | | |
| Battery B2 | | 2.0 mass % | Good | 91% |
| (Negative | | | | |
| electrode b2) | | | | |
| Battery Z1 | 0/10 | 1.0 mass % | Good | 90% |
| (Negative | | | | |
| electrode z1) | | | | |
| Battery Y | | 2.0 mass % | Good | 85% |
| (Negative | | | | |
| electrode y) | | | | |

As is clear from Table 2, the batteries A1, B1, and B2 including the negative electrodes a1, b1, and b2, in which CMC and PEO were added to the slurries and the mass of CMC was greater than the mass of PEO, had improved low-temperature characteristics (the deposition of lithium on the surface of the negative electrode could be reduced). In contrast, the batteries Z1 and Y including the negative electrodes z1 and y, in which CMC alone (no PEO) was added to the slurry, had poor low-temperature characteristics (the deposition of lithium on the surface of the negative electrode increased).

Precipitation was slightly increased in the negative electrode mixture slurry used in the preparation of the negative electrode b1, in which the percentage of the total amount of PEO and CMC with respect to the total amount of the negative electrode mixture layer was 0.5% by mass. This is probably because a small percentage of the total amount of the CMC and the lithium ion conducting polymer with respect to the total amount of the negative electrode mixture layer results in insufficient dispersion stability of the negative electrode active material in the negative electrode mixture layer. It is therefore assumed that a further decrease in the percentage of the total amount of PEO and CMC with respect to the total amount of the negative electrode mixture layer results in a further increase in precipitation.

The effect of improving low-temperature characteristics was reduced in the battery B2 including the negative electrode b2, in which the percentage of the total amount of PEO and CMC with respect to the total amount of the negative electrode mixture layer was 2.0% by mass. This is probably because a greater percentage of the total amount of PEO and CMC with respect to the total amount of the negative electrode mixture layer results in a lower deintercalation efficiency of lithium ions in the negative electrode active material, thereby increasing the deposition of lithium on the surface of the negative electrode active material. It is therefore assumed that a further increase in the percentage of the total amount of PEO and CMC with respect to the total amount of the negative electrode mixture layer results in a still smaller effect of improving the low-temperature characteristics.

Considering these, the percentage of the total amount of PEO and CMC with respect to the total amount of the negative electrode mixture layer must be 0.2% by mass or more and 2.2% by mass or less, particularly preferably 0.5% by mass or more and 1.5% by mass or less.

### Third Example

### Example 1

A negative electrode and a battery were fabricated in the same manner as in the example 1 of the first example except that the lithium ion conducting polymer was PEO having a molecular weight of 600,000 (manufactured by Sigma-Aldrich Co.).

The negative electrode and the battery thus fabricated are hereinafter referred to as a negative electrode c1 and a battery C1.

### Example 2

A negative electrode and a battery were fabricated in the same manner as in the example 1 of the first example except that the lithium ion conducting polymer was PEO (manufactured by Sigma-Aldrich Co.) having a molecular weight of 100,000.

The negative electrode and the battery thus fabricated are hereinafter referred to as a negative electrode c2 and a battery C2.

### Example 3

A negative electrode and a battery were fabricated in the same manner as in the example 1 of the first example except that the lithium ion conducting polymer was poly(ethylene glycol) (PEG) having a molecular weight of 25,000 (manufactured by Sigma-Aldrich Co.).

The negative electrode and the battery thus fabricated are hereinafter referred to as a negative electrode c3 and a battery C3.

### Experiment 1

The precipitation of the negative electrode mixture slurries used in the preparation of the negative electrodes c1 to c3 was examined in the same manner as in the experiment 1 of the first example. Table 3 shows the results. Table 3 also shows the precipitation of the negative electrode mixture slurry used in the preparation of the negative electrode a1.

### Experiment 2

The low-temperature characteristics of the batteries C1 to C3 were examined in the same manner as in the experiment 2 of the first example. Table 3 shows the results. Table 3 also shows the low-temperature characteristic values of the battery A1.

TABLE 3

| | Percentage of the | | | | |
|---|---|---|---|---|---|
| | amount of PEO and | | | | |
| | CMC with respect to | | | | Low- |
| Battery No. | the amount of | PEO | Molecular | | temperature |
| (Negative | negative electrode | (PEG)/CMC | weight of | Degree of | characteristic |
| electrode No.) | mixture layer | mass ratio | PEO (PEG) | precipitation | value |
| Battery C1 | 1.0 mass % | 2/8 | 600000 | Good | 92% |
| (Negative | | | | | |
| electrode c1) | | | | | |
| Battery A1 | | | 300000 | Good | 95% |
| (Negative | | | | | |
| electrode a1) | | | | | |
| Battery C2 | | | 100000 | Good | 93% |
| (Negative | | | | | |
| electrode c2) | | | | | |
| Battery C3 | | | 25000 | Fair | 91% |
| (Negative | | | | | |
| electrode c3) | | | | | |

As is clear from Table 3, the negative electrode mixture slurries used in the preparation of the negative electrodes a1, c1, and c2, in which the molecular weight of PEO was 100,000 to 600,000, had a reduced amount of precipitation. The batteries A1, C1, and C2, which included these negative electrodes, had improved low-temperature characteristics (the deposition of lithium on the surface of the negative electrode could be controlled). In contrast, the negative electrode mixture slurry used in the preparation of the negative electrode c3, in which the molecular weight of PEG was 25,000, had a slightly large amount of precipitation. The battery C3, which included the negative electrode, had slightly deteriorated low-temperature characteristics (the effect of reducing deposition of lithium on the surface of the negative electrode was decreased). Thus, PEO for use in lithium ion conducting polymers preferably has a molecular weight in the range of 100,000 to 600,000. This is because a molecular weight of less than 100,000 may result in a small thickening effect and an increased amount of precipitation. On the other hand, a molecular weight of more than 600,000 may result in the formation of a thick polymer film on the surface of the negative electrode active material, resulting in reduced lithium ion conductivity or the aggregation of the negative electrode active material.

### Fourth Example

### Example

A negative electrode and a battery were fabricated in the same manner as in the example 1 of the first example except that in the preparation of the negative electrode mixture slurry artificial graphite was mixed with an aqueous PEO solution and then with an aqueous CMC solution.

The negative electrode and the battery thus fabricated are hereinafter referred to as a negative electrode d and a battery D.

### Experiment 1

The precipitation of the negative electrode mixture slurry used in the preparation of the negative electrode d was examined in the same manner as in the experiment 1 of the first example. Table 4 shows the results. Table 4 also shows the precipitation of the negative electrode mixture slurry used in the preparation of the negative electrode a1.

### Experiment 2

The low-temperature characteristics of the battery D was examined in the same manner as in the experiment 2 of the first example. Table 4 shows the results. Table 4 also shows the low-temperature characteristic values of the battery A1.

TABLE 4

| | Percentage of the amount | | | | |
|---|---|---|---|---|---|
| | of PEO and CMC with | | | | Low- |
| Battery No. | respect to the amount of | | Timing of | | temperature |
| (Negative | negative electrode mixture | PEO/CMC | addition | Degree of | characteristic |
| electrode No.) | layer | mass ratio | of PEO | precipitation | value |
| Battery A1 | 1.0 mass% | 2/8 | After | Good | 95% |
| (Negative | | | CMC | | |
| electrode a1) | | | | | |
| Battery D | | | Before | Fair | 93% |
| (Negative | | | CMC | | |
| electrode d) | | | | | |

As is clear from Table 4, the negative electrode a1 prepared using a negative electrode mixture slurry in which the addition of PEO followed the addition of CMC had less precipitation than the negative electrode d prepared using a negative electrode mixture slurry in which the addition of PEO was followed by the addition of CMC. Furthermore, the battery A1 including the negative electrode a1 had better low-temperature characteristics than the battery D including the negative electrode d (the deposition of lithium on the surface of the negative electrode could be controlled).

CMC is a dispersant more effective than PEO. Thus, the addition of an aqueous CMC solution to a negative electrode active material before the addition of PEO allows CMC to be adsorbed on the surface of the negative electrode active material, thereby ensuring high dispersion of the negative electrode mixture slurry. The subsequent addition of PEO to the well-dispersed negative electrode mixture slurry allows the surface of the negative electrode active material to be covered with a uniform composite film of CMC and PEO. This probably resulted in the difference in the characteristics of the battery A1 and the battery D. Thus, in the preparation of a negative electrode mixture slurry, it is desirable that the addition of PEO follow the addition of CMC.

The present invention can be applied to driving power supplies for mobile information terminals, such as mobile phones, notebook computers, and PDAs, and driving power supplies for applications requiring high output power, such as HEVs and electric power tools.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A nonaqueous electrolyte secondary battery comprising:
a negative electrode having a negative electrode mixture layer on at least one surface of a negative collector;
a positive electrode;
a separator disposed between the positive electrode and the negative electrode; and
a nonaqueous electrolyte,
wherein the negative electrode mixture layer comprises a negative electrode active material, a lithium ion conducting polymer, carboxymethylcellulose, and a latex binder,
the mass of the carboxymethylcellulose is equal to or greater than the mass of the lithium ion conducting polymer, and the percentage of the total amount of the carboxymethylcellulose and the lithium ion conducting polymer with respect to the total amount of the negative electrode mixture layer is in the range of from 0.2% by mass to 2.2% by mass.

2. The nonaqueous electrolyte secondary battery according to claim 1, wherein the mass ratio of the lithium ion conducting polymer to the carboxymethylcellulose is in the range of from 0/10 to 4/6.

3. The nonaqueous electrolyte secondary battery according to claim 1, wherein the lithium ion conducting polymer is at least one polymer selected from the group consisting of a poly(ethylene oxide) and a poly(ethylene oxide) derivative.

4. The nonaqueous electrolyte secondary battery according to claim 3, wherein the poly(ethylene oxide) and a poly(ethylene oxide) derivative have a molecular weight in the range of from 50,000 to 1,000,000.

5. A method for manufacturing a nonaqueous electrolyte secondary battery, comprising:
mixing a negative electrode active material with an aqueous solution containing carboxymethylcellulose to form a mixture and adding a lithium ion conducting polymer and a latex binder to the mixture to form a negative electrode mixture slurry;
applying the negative electrode mixture slurry to at least one surface of a negative collector to form a negative electrode; and
placing a separator between the negative electrode and a positive electrode to form an electric-power generating element and impregnating the electric-power generating element with a nonaqueous electrolyte.

6. The nonaqueous electrolyte secondary battery according to claim 1, wherein the the percentage of the total amount of the carboxymethylcellulose and the lithium ion conducting polymer with respect to the total amount of the negative electrode mixture layer is in the range of from 0.5% by mass to 1.5% by mass.

7. The nonaqueous electrolyte secondary battery according to claim 4, wherein the poly(ethylene oxide) and a poly(ethylene oxide) derivative have a molecular weight in the range of from 100,000 to 600,000.

8. The nonaqueous electrolyte secondary battery according to claim 1, wherein the lithium ion conducting polymer is at least one polymer selected from the group consisting of a poly(ethylene oxide), a poly(ethylene oxide) derivative, a poly(methyl methacrylate) and a polyacrylonitrile.
